(19) United States
(12) Patent Application Publication
(10) Pub. No.: US 2006/0284439 A1
(43) Pub. Date: Dec. 21, 2006

(54) Loading and unloading system for a truck having a bed

(76) Inventor: Nena A. Carroll, Comanche, TX (US)

Correspondence Address: LAW OFFICES OF ERIC KARICH, 2807 ST. MARK DR., MANSFIELD, TX, 76063, US

(21) Appl. No.: 11/360,647

(22) Filed: Feb. 23, 2006

Related U.S. Application Data
(63) Continuation of application No. 11/153,175, filed on Jun. 15, 2005, now Pat. No. 7,128,357.

(51) Int. Cl. B62D 25/00

(52) U.S. Cl. 296/61

(57) ABSTRACT

A loading and unloading system for a truck has a ramp and a ramp mounting assembly adapted for mounting the ramp such that the ramp can be moved from a stored position, wherein the ramp is positioned within a ramp storage compartment, to an extended position wherein the ramp extends outwardly from the ramp storage compartment. The system further includes a tailgate that is mounted on one of the pair of sidewalls of the truck with a tailgate mounting hinge assembly such that the tailgate can be pivoted between a closed position and an open position.

### CROSS-REFERENCE TO RELATED APPLICATIONS

This application for a utility patent is a continuation-in-part of a previously filed utility patent, still pending, having the application Ser. No. 11/153,175, filed Jun. 15, 2005.

### STATEMENT REGARDING FEDERALLY SPONSORED RESEARCH

Not Applicable

### BACKGROUND OF THE INVENTION

1. Field of the Invention

This invention relates generally to loading and unloading systems for pickup trucks, and more particularly to a loading and unloading system in which the tailgate of the pickup truck does not interfere with the loading and unloading system.

2. Description of Related Art

Ramps are commonly used to facilitate loading of objects into, and unloading objects from, truck beds. A problem arises when using a ramp with a typical pickup truck in that the tailgate gets in the way, requiring a special extension that allows the ramp to extend out over the tailgate. There are various examples of this type of construction, including the following:

Walkden, U.S. Pat. No. 5,795,125, teaches an extendable ramp assembly for a pickup truck. The ramp assembly includes a platform assembly having a hollow interior that is bolted to the floor of the truck bed. A sliding platform is adjustably positioned within the platform assembly to allow for adjusting the angle of incline of an extendable ramp which is attached thereto. The sliding platform is adapted to extend over the tailgate, which remains in a standard position. A hinge plate is connected to the ramp to allow for a relatively smooth and continuous surface between the ramp and the top surface of the platform assembly.

Agee, U.S. Pat. No. 4,601,632, teaches a stowable ramp assembly that is fairly similar to the Walken reference. A generally thin, flat and elongated ramp sleeve is adapted for placement on a truck bed with the rearward end thereof positioned at the rearward end of the bed. An extension sleeve is telescopically slidable within the ramp sleeve and an elongated ramp is telescopically slidably received in the extension sleeve. The extension sleeve is rearwardly slidable to a working position over the lowered horizontal tailgate and the ramp is extendable rearwardly therefrom in the working position and connected to the extension sleeve for up and down pivotal movement of the rearward end of the ramp.

Other similar structures are shown in Noble, U.S. Pat. No. 3,870,170, Uher, U.S. Pat. No. 4,624,619, O'Donnell, et al., U.S. Pat. No. 6,880,194, Goeser, et al., U.S. Pat. No. 4,685,857, Grant, U.S. Pat. No. 5,257,894, Belanger, U.S. Pat. No. 5,570,989,

Palmer, Jr., et al., U.S. Pat. No. 6,390,761, Lance, U.S. Pat. No. 5,907,276, Boone, U.S. Pat. No. 5,312,149, Belanger, U.S. Pat. No. 355,518, and Port, U.S. Pat. No. 357,789.

The prior art also teaches various other compartments in a truck undercarriage, including the following:

Foster, et al., U.S. Pat. No. 6,328,366, teaches a vehicle body with an undercarriage storage compartment for storing items such as a spare tire, tools and/or other types of equipment underneath a pick-up truck bed. The vehicle body includes a generally flat truck bed bottom member that extends in a longitudinal direction along the vehicle. The bottom member is mounted to a vehicle structure such as, a vehicle frame, chassis, or unibody member. The storage compartment has a support surface extending underneath the bottom member for supporting items such as the spare tire and associated tools. The storage compartment slides to an open position to allow access to the spare tire and tools and is then returned to a closed position to store the tire and tools within the storage compartment. In one embodiment, the support surface is tiltable to allow ramp access to the truck bed.

A stowable tailgate is also shown in the prior art, including the following:

Bailey, U.S. Pat. No. 6,464,278, teaches a vehicle tailgate mounted on sliding pivots wherein a channel portion of the sliding pivots are on the vehicle and have the initial entry portion sloping downwardly in a direction toward the front end of the vehicle. The tailgate has two spaced apart pins (each preferably with a roller thereon) on each of opposite edges and all four slide in the channels with one pair being on the sloping portion of the track thus by gravity biasing the tailgate into its retracted position in a storage compartment provided under a floor of the vehicle.

Jones, U.S. Pat. No. 4,580,828, and Couvillion, U.S. Pat. No. 5,123,692, teach other embodiments of a tailgate storable beneath a truck bed. P. C. Trautmann, U.S. Pat. No. 3,010,760, teaches a retractable tailgate for a station wagon.

It would thus be beneficial to have a loading and unloading system for a truck with a bed (such as a pickup truck) including a ramp that does not have to be completely removed from a storage area prior to use, and does not require an extension to extend out and over a tailgate.

### SUMMARY OF THE INVENTION

The present invention teaches certain benefits in construction and use which give rise to the objectives described below.

The present invention provides a loading and unloading system for a truck having a bed and a pair of sidewalls. The system includes a ramp that is adapted to fit within a ramp storage compartment mounted adjacent to the bed. A ramp mounting assembly is adapted for mounting the ramp such that the ramp can be moved from a stored position, wherein the ramp is positioned within the ramp storage compartment, to an extended position wherein the ramp extends outwardly from the ramp storage compartment through an opening in the ramp storage compartment. The system further includes a tailgate that is mounted on one of the pair of sidewalls of the truck with a tailgate mounting hinge assembly such that the tailgate can be pivoted between a closed position and an open position. In the closed position, the tailgate lockingly engages the other of the pair of sidewalls, blocks the opening in the ramp storage compartment, and locks the ramp in the ramp storage compartment. In the open position, the tailgate pivots away from the other of the pair of sidewalls such that the tailgate does not block the opening of the ramp storage compartment and does not impede the movement of the ramp to the extended position.

A primary objective of the present invention is to provide a loading and unloading system for a truck having advantages not taught by the prior art.

Another objective is to provide a loading and unloading system for a truck that includes a ramp to facilitating the loading and unloading of the truck, and a tailgate that can be either used to close the bed of the truck, or be moved aside so as to not interfering with the operation of the ramp.

A further objective is to provide a system that is inexpensive to manufacture and install, and easy to use.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a rear perspective view of a portion of a pickup truck having a bed that includes one embodiment of a loading and unloading system, the view illustrating a tailgate in an open position and a ramp in a stored position;

FIG. 2 is a rear perspective view of the portion of the pickup truck of FIG. 1 wherein the ramp of the loading and unloading system has been moved from the stored position to an extended position;

FIG. 3 is a side elevation view of the portion of the pickup truck of FIG. 1 illustrating the ramp in the stored position, however, wherein the tailgate has been moved to a closed position;

FIG. 4 is a side view of the portion thereof, wherein the ramp has been moved to the extended position, and wherein the tailgate has been moved from the closed position to the open position; and

FIG. 5 is a rear elevation view of the ramp in the stored position.

### DETAILED DESCRIPTION OF THE INVENTION

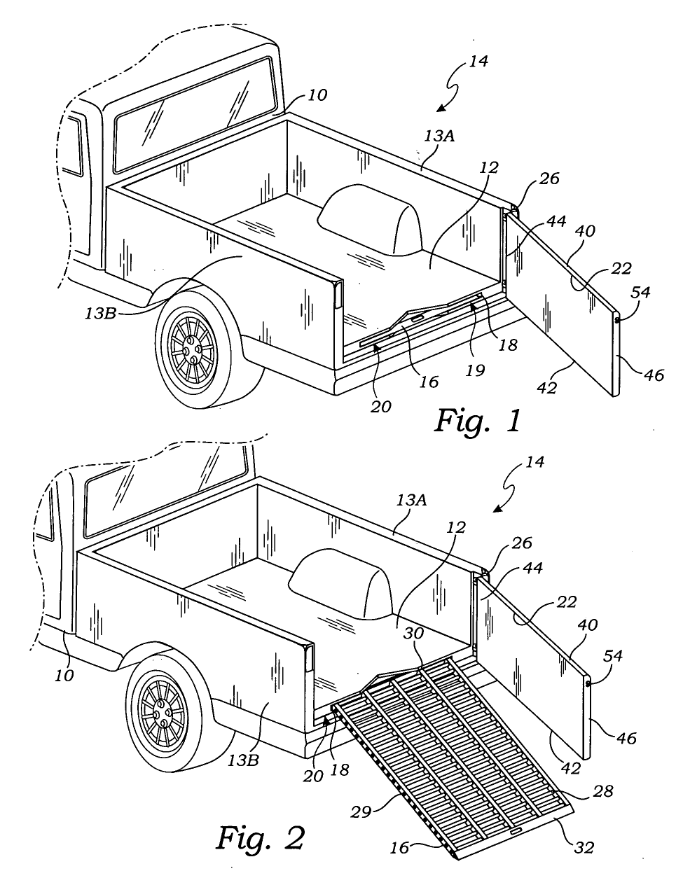

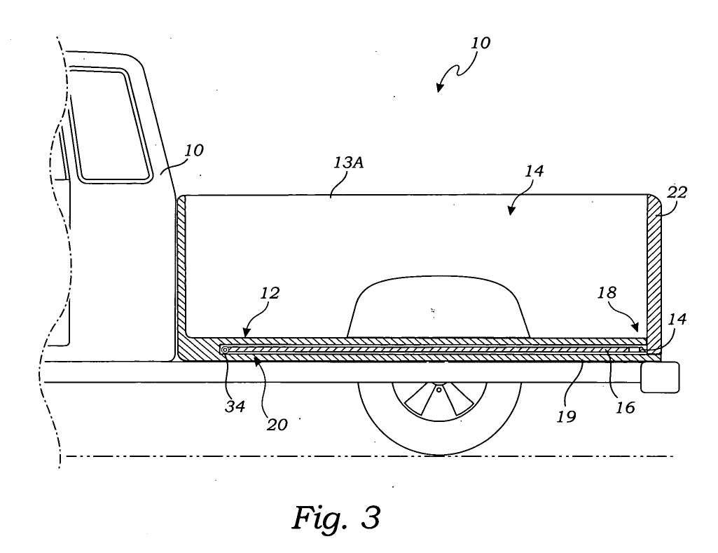

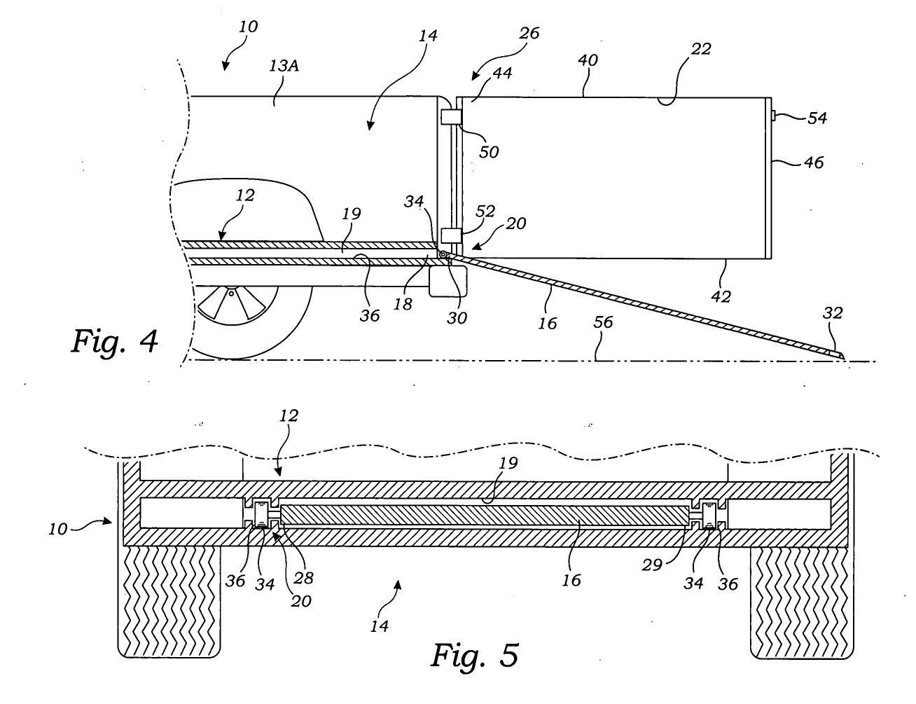

FIGS. 1-5 illustrate a pickup truck 10 having a bed 12 that includes one embodiment of a loading and unloading system 14. FIG. 1 is a rear perspective view of the pickup truck 10 that includes the loading and unloading system 14, illustrating a ramp 16 of the system 14 in a stored position. FIG. 2 is a rear perspective view thereof illustrating the ramp 16 once it has been moved from the stored position to an extended position. FIGS. 3 and 4 are side elevation views of the pickup truck 10 illustrating, in FIG. 3, the ramp 16 in the stored position and a tailgate 22 of the loading and unloading system 14 in a closed position, and, in FIG. 4, illustrating the ramp 16 in the extended position and the tailgate 22 in an open position. FIG. 5 is a rear elevation view further illustrating the ramp 16 in the stored position within the ramp storage compartment 19.

In the embodiment of FIGS. 1-5, the loading and unloading system 14 includes the ramp 16, the ramp storage compartment 19 adapted to receive the ramp 16, a ramp mounting assembly 20 positioned in the ramp storage compartment 19, the tailgate 22, and a tailgate mounting hinge assembly 26. The ramp storage compartment 19 is preferably formed under the bed 12, either as an integral component of the bed 12, or as a bolt-on addition. In alternative embodiments, the ramp storage compartment 19 may also be mounted on top of the bed 12 (as shown in Walkden, U.S. Pat. No. 5,795,125, which is hereby incorporated by reference), or otherwise closely associated therewith.

The ramp 16 is received in the ramp storage compartment 19 via the ramp mounting assembly 20 such that the ramp 16 can be moved between a stored position and an extended position. In the stored position, as shown in FIG. 1, the ramp 16 is located in the ramp storage compartment 19 (shown in FIG. 4). In the extended position, shown in FIG. 2, the ramp 16 extends outwardly from the ramp storage compartment 19 (shown in FIG. 4) through an opening 18, and may advantageously be used to load objects into, and/or unload objects from, the bed 12 of the pickup truck 10.

The ramp 16 has opposed right and left sides 28 and 29, a front end 30, and a back end 32 opposite the front end 30. In the present embodiment, the ramp mounting assembly 20 includes a pair of wheels 34 (shown in greater detail in FIGS. 4 and 5) each extending outwardly from one of the sides 28 and 29 at the front end 30.

The ramp mounting assembly 20 further includes a pair of tracks 36 adapted to retain the wheels of the ramp 16. While this embodiment is currently preferred, those skilled in the art will recognize that the ramp mounting assembly 20 could also include alternative structures, including posts rather than wheels, and various other forms of tracks, guides, sliders, rollers or other mechanisms known to those skilled in the art, and these alternative embodiments should be considered within the scope of the invention as claimed.

The tailgate 22 is generally similar to a standard tailgate, preferably having a generally rectangular construction with opposed top and bottom edges 40 and 42 connected by opposed first and second side edges 44 and 46. A tailgate mounting hinge assembly 26 functions to hingably mount the tailgate 22 on one of the pair of sidewalls 13A such that the tailgate 22 can be pivoted between a closed position and an open position. In the closed position, the tailgate 22 lockingly engages the other of the pair of sidewalls 13B to block the opening in the ramp storage compartment 19, thereby locking the ramp 16 in the ramp storage compartment 19. In the open position, the tailgate 22 pivots away from the other of the pair of sidewalls 13B such that the tailgate 22 does not block the opening in the ramp storage compartment 19 and does not impede the movement of the ramp 16 to the extended position.

In the preferred embodiment, the tailgate mounting hinge assembly 26, as best shown in FIG. 4, includes a first hinge 50 and a second hinge 52 that pivotally mount the first side edge 44 of the tailgate 22 to one of the pair of sidewalls. Obviously, while two hinges 50 and 52 are shown, more than two hinges, or one larger hinge, could also be used. The tailgate 22 further includes a latch mechanism 54 on the second side edge 46 for releasably latching the tailgate 22 in the closed position.

Those skilled in the art will recognize that the tailgate mounting hinge assembly 26 and the latch are generally well known in the art and are therefore not described in greater detail herein. Furthermore, the tailgate mounting hinge assembly 26 and the latch 54 could also include alternative structures, including various forms of hinges and pivoting mechanisms known to those skilled in the art, and various forms of latching mechanisms 54, and these alternative embodiments should be considered within the scope of the invention as claimed.

FIG. 4 is a side view of the portion of the pickup truck 10 of FIG. 3 wherein the ramp 16 has been moved to the extended position. In the embodiment of FIG. 4, when the ramp 16 is in the extended position, the wheels of the ramp 16 that extend outwardly from the sides at the front end 30 are retained within the tracks of the ramp mounting assembly 20, and the back end 32 of the ramp 16 is positioned on a ground surface 56 behind the pickup truck 10. In the extended position of FIG. 4, the ramp 16 may advantageously be used to load objects into, and/or unload objects from, the bed 12 of the pickup truck 10. It is noted that the ramp 16 is easily transitioned from the stored position (see FIGS. 1 and 3) to the extended position of FIG. 4 via the wheels, and there is advantageously no need to completely remove the ramp 16 from the ramp storage compartment 19 prior to use.

FIG. 5 is a rear elevation view of the portion of the pickup truck 10 of FIG. 3, further illustrating the ramp 16 is in the stored position within the ramp storage compartment 19.

In alternative embodiments not illustrated herein, the bed 12 may include a covered opening to facilitate installation and maintenance of the ramp 16. Furthermore, the ramp 16 may also be formed of two or more parts that telescopically or otherwise engage each other to further extend the length of the ramp 16. While these and other alternative features are not disclosed herein, it is contemplated that these and other features may be included by those skilled in the art, and such alternatives should be considered within the scope of the invention, as claimed herein.

While the invention has been described with reference to at least one preferred embodiment, it is to be clearly understood by those skilled in the art that the invention is not limited thereto. Rather, the scope of the invention is to be interpreted only in conjunction with the appended claims.

1. A loading and unloading system for a truck having a bed and a pair of sidewalls, each of the pair of sidewalls extending upwardly from opposite sides of the bed, the system comprising:
a ramp;
a ramp storage compartnent formed under the bed of the truck and adapted to receive the ramp;
a ramp mounting assembly for mounting the ramp such that the ramp can be moved from a stored position, wherein the ramp is positioned within the ramp storage compartment, to an extended position wherein the ramp extends outwardly from the ramp storage compartment through an opening in the ramp storage compartment;
a tailgate; and
a tailgate mounting hinge assembly for hingably mounting the tailgate on one of the pair of sidewalls such that the tailgate can be pivoted between a closed position and an open position, wherein in the closed position the tailgate lockingly engages the other of the pair of sidewalls, blocks the opening in the ramp storage compartment, and locks the ramp in the ramp storage compartment, and wherein in the open position the tailgate pivots away from the other of the pair of sidewalls such that the tailgate does not block the opening of the ramp storage compartment and does not impede the movement of the ramp to the extended position.

2. The loading and unloading system as recited in claim 1, wherein the ramp has two opposed sides, two opposed ends, and a pair of wheels each extending outwardly from a different one of the sides at one of the ends of the ramp, and wherein the ramp mounting assembly is adapted to retain the wheels of the ramp.

3. The loading and unloading system as recited in claim 2, wherein the ramp mounting assembly comprises a pair of tracks each adapted to retain a different of the wheels of the ramp.

4. The loading and unloading system as recited in claim 1, wherein the ramp storage compartment comprises an upper wall that forms a portion of a floor of the bed of the truck.

5. The loading and unloading system as recited in claim 1, wherein the track is a pickup truck.

6. A loading and unloading system for a truck having a bed and a pair of sidewalls, each of the pair of sidewalls extending upwardly from opposite sides of the bed, the system comprising:
a ramp;
a ramp storage compartment formed adjacent to the bed of the truck and adapted to receive the ramp;
a ramp mounting assembly for mounting the ramp such that the ramp can be moved from a stored position, wherein the ramp is positioned within the ramp storage compartment, to an extended position wherein the ramp extends outwardly from the ramp storage compartment through an opening in the ramp storage compartnent;
a tailgate; and
a tailgate mounting hinge assembly for hingably mounting the tailgate on one of the pair of sidewalls such that the tailgate can be pivoted between a closed position and an open position, wherein in the closed position the tailgate lockingly engages the other of the pair of sidewalls, blocks the opening in the ramp storage compartment, and locks the ramp in the ramp storage compartment, and wherein in the open position the tailgate pivots away from the other of the pair of sidewalls such that the tailgate does not block the opening of the ramp storage compartment and does not impede the movement of the ramp to the extended position.
